(19) United States
(12) Patent Application Publication
(10) Pub. No.: US 2007/0074678 A1
(43) Pub. Date: Apr. 5, 2007

(54) Animal collar having a built in identification card and water tight pouch

(76) Inventor: John Curtis Fritschler, Aurora, CO (US)

Correspondence Address: JOHN C. FRITSCHLER, 19651 EAST IDA CIR., AURORA, CO, 80015, US

(21) Appl. No.: 11/242,552

(22) Filed: Oct. 4, 2005

(51) Int. Cl. A62B 35/00

(52) U.S. Cl. 119/863

(57) ABSTRACT

This invention is an animal collar having an inset pouch or pocket that can contain an identification card or tag. Modern collars have identification tags that hang from the collar around their buckles. These collars and tags do not allow for changing the identification information easily and often the tags hanging from the collar get lost or ruined through the animal's activities. It would be desirable to provide animal owners with the alternative choice of a collar that allows for easy replacement of the identification information on the animal and provide contact information for the owner. This way, there is an easy way to tell someone who finds a lost pet the correct phone number to call when the owner is away. Or the new identification can direct the person to call whoever is watching over the pet rather than calling a number where nobody is home.

An animal collar which permits an individual to place within the water tight center of the collar an identification tag or card, an adjustment of the length of the collar is accomplished by means of a locking mechanism on opposite ends of the length of the collar. This assembly attaches the first end portion of the device to the second end portion of the device and for providing a circular configuration for positioning the device around an animal's neck. The top surface of the device being positioned outwardly and the bottom surface of the device being positioned inwardly whereby information provided on the information or identification assembly is viewable without removal of the device from the animal. Contained in the center of the strip is a water tight pouch that can contain an identification card or tag. At the base of this pouch it extrudes beyond the pouch section of the strip of flexible material in a horizontal manner ending with a sealing substance. The extruding portion can wrap over the aforementioned pouch and seal the identification card within.

### BRIEF DESCRIPTION OF THE DRAWINGS

In the following, the present invention will be explained in detail on the basis of a preferred embodiment and the associated drawings, in which

FIG. 1 is a top plan view of Animal collar having a built in identification card and water tight pouch

FIG. 2 is a left side elevation view of the device of FIG. 1.

FIG. 3 is a right side elevation view of the device of FIG. 1.

FIG. 4 is a bottom plan view of the device of FIG. 1.

FIG. 5 is perspective view illustrating the placing of the device in a closed position that would circle an animal's neck allowing the identification information to be seen without removing the collar.

### DETAILED DESCRIPTION

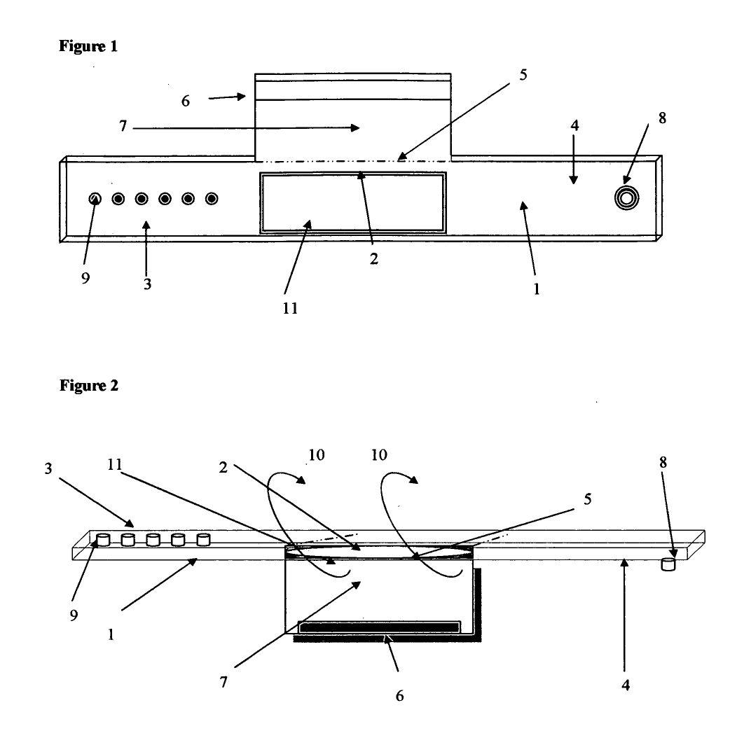

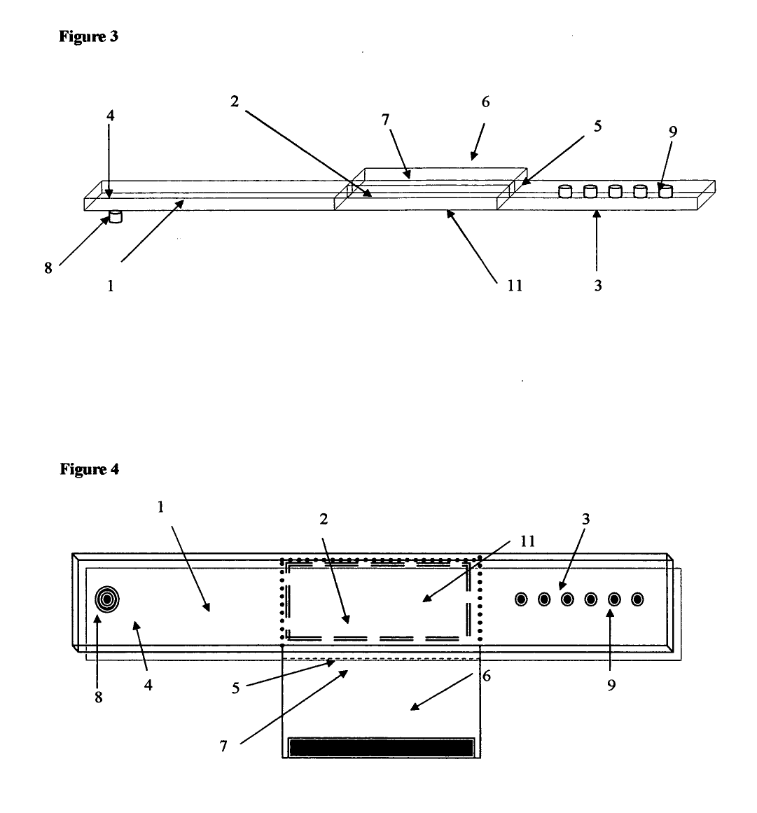

An animal collar embodying the invention, as shown in FIGS. 1, 2, 3, 4 and 5 includes a strip 1, 3 of material, which may be of any strong, durable, flexible material, most preferably a vinyl fabric. Other materials such as leather or nylon may be appropriate alternatives. The strip 1 has a first end 3 and a second end 4. A male end fastener 8 comprised of any way of clasping the first end including snaps, buckles, tape, glue, Velcro or any other locking mechanism is attached to the first end 3, to receive the female end 9 of the aforementioned locking mechanism, extending between the top and bottom sides 3, 4 of the first and second ends.

In the center of the first and second ends 3, 4 the pocket 2 (for inserting identification cards, tags, etc.) is placed between the overlapped layers of the first end by stitching, gluing, heat sealing or any other form of closing on either side of the of the first and second ends 3, 4.

The pocket 2 will be of sufficient size to place or insert identification cards, tags, etc in it and be legible to a person reading it on the collar with out having to remove the color for identification purposes. Said pocket 2 will be made of a clear or translucent material 11 therefore allowing the identification card, tags, etc to be read and the information understood.

Extending horizontal of pocket 2 will be a flap 7 of a similar or different pliable material that is of the same mold or attached by stitching, gluing, heat sealing, molding or any other form of attaching to the first and second ends. Said flap 7 will be of any length that is determined to be necessary to functionally seal of the pocket.

FIG. 2 shows how said flap 7 will be functionally able to bend 5, 11 parallel to the opening of the pocket 2 to make a water and/or air tight seal of the pocket. On the outer most section of the flap 7 may be a snaps, buckles, tape, glue, Velcro or any other locking, securing or sealing mechanism 6 to close the aforementioned flap.

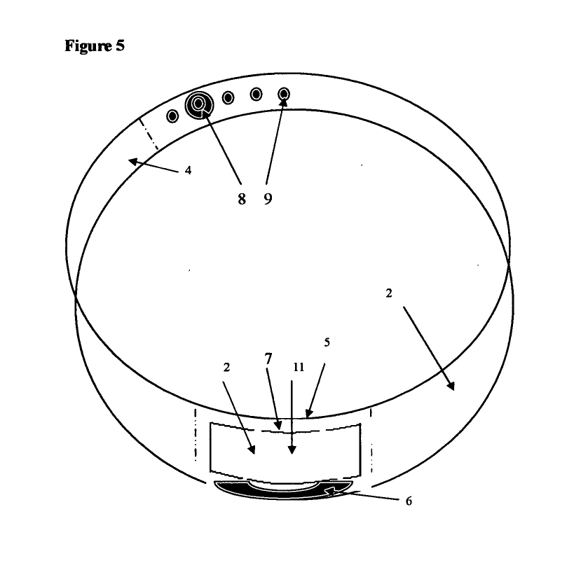

It should be noted that the collar is adjustable FIG. 5 based upon where the male 8 and female 9 locking mechanisms are placed along the length of the first end 3 and a second end 4. Any adjustment is achieved by moving the adjuster. The collar is meant to be both functional and to provide an attractive appearance.

Since the invention is subject to modifications and variations, it is intended that the foregoing description and the accompanying drawings shall be interpreted as only illustrative of the invention defined by the following claims.

What is claimed is:

1. An animal collar (1) comprising a strip of flexible material having first and second ends (3, 4), secured by a locking means comprising of a mechanism to an intermediate portion of the strip including an adjustable-length means (8, 9) for connecting together said strap end portions to define a circular collar of variable length for reducing the size of the collar to fit the neck size of the animal.

2. Contained in the center of the strip is a water tight pouch (2) that can contain an identification card or tag. The base of this pouch it extrudes beyond the pouch section of the strip of flexible material in a horizontal manner (7) ending with a sealing substance (6). the extruding portion can wrap over the aforementioned pouch (5, 10) and seal the identification card within (11).

3. The animal collar of claim 1, wherein it comprises of a strip of flexible material having first and second ends (3, 4).

4. The animal collar of claim 1, wherein the first end of the strip (3) has a male end fastener (8), glue, snaps or tape type substance, male buckle end or other means of fastening.

5. The animal collar of claim 1, wherein the second end (4) of the strip has a number of holes or a number of female end fasteners (9), glue, snaps, or tape type substance, female buckle end or other means of fastening.

6. The animal collar of claim 1, wherein the product is made entirely of flexible materials (1).

7. The animal collar of claim 1, further having an inset pocket (2) by stitching, glue, molding between overlapped layers or any other manner for making a pocket on or in the strip.

8. The animal collar of claim 7, wherein the center of the strip (7) is extended horizontal beyond the opening of the pocket to make a flap.

9. The animal collar of claim 8, wherein the center of the strip is horizontally extended beyond the opening of the pocket and the flap can be wrapped back or folded over the pocket (5, 10).

10. The animal collar of claim 8, wherein the center of the strip or flap can be sealed (6), snapped, fastened or glued to enable the retention of an identification tag in the aforementioned pocket (11).

11. The animal collar of claim 8 can be sealed, snapped, fastened or glued (6) to enable the retention of an identification card in the aforementioned pocket (11).

12. The animal collar of claim 8 can be sealed, fastened, snapped or glued (6) to make a water tight pocket for the placement of an identification card (11).

13. This assembly attaches the first end portion (3) of the device to the second end (4) portion of the device and for providing a circular configuration for positioning the device around an animal's neck (FIG. 5).

14. The top surface of the device being positioned outwardly and the bottom surface of the device being positioned inwardly whereby information provided on the information or identification assembly is viewable without removal of the device from the animal (11) (FIG. 5).
